(19) United States
(12) Patent Application Publication
(10) Pub. No.: US 2004/0248547 A1
(43) Pub. Date: Dec. 9, 2004

(54) Integration of billing between cellular and wlan networks

(76) Inventors: Johan Philsgard, Stockholm (SE); Mats Mellstrand, Kalmar (SE)

Correspondence Address: LADAS & PARRY LLP, 224 SOUTH MICHIGAN AVENUE, SUITE 1200, CHICAGO, IL, 60604, US

(21) Appl. No.: 10/491,818

(22) PCT Filed: Oct. 8, 2002
(86) PCT No.: PCT/SE02/01825

(30) Foreign Application Priority Data
Oct. 8, 2001 (SE) 0103337-2

(51) Int. Cl. H04M 11/00

(52) U.S. Cl. 455/405

(57) ABSTRACT

According to the illustrated embodiment, the authentication of a cellular network customer in a LAN hotspot area is made possible by a Sign-up server (SUP). The customer enters his cellular phone number (MSISDN) and the SUP contacts the cellular network's HLR via GGSN to get customer identification information (MSIN). SUP creates an account in the system of the LAN network. The generated account details are sent to the users'cellular terminal, e.g. by SMS or e-mail. The usage of LAN services is calculated and the resulting billing information, CDR:s including the MSIN ID, is sent to the cellular network billing system and the customer gets billed by their cellular network operator.

### TECHNICAL FIELD OF THE INVENTION

The present invention refers to communication between a data communication network and a cellular network, enabling a cellular network customer to use his customer ID to access services in the data communication network. Especially, the present invention refers to communication between a wireless data communication network, such as WLAN, and a cellular network. The connection between the networks also enables billing information, i.e. consumption of the data communication network service, to be communicated to the cellular network billing system.

### BACKGROUND OF THE INVENTION

Today, there exist different systems for billing services provided to a customer by means of a data communication network. In the existing systems there is often a need of a separate subscription or agreement between the customer and a service provider, e.g. an operator of the data communication network. Such a subscription can for example be an Internet subscription or the like. However, before concluding an agreement with the customer, the service provider often contacts a credit-rating agency or the like to find out the customer's credit rating. Thus a drawback with the existing system is that the service provider have to contact the credit-rating agency for each new customer, which is both time-consuming and costly for the service provider.

By means of the present invention, the customer can in a much easier way than today get access to and use public data communication networks. This is achieved by letting the customer use his existing relation with a cellular network operator. The billing are simplified—the customer gets one bill for all his network services, and access and authentication is also made easier since it is performed towards the cellular network.

### OBJECT OF THE INVENTION

Objects of the present invention is to enable:

self-provisioning of WLAN access account for cellular network customers;

secure transfer of WLAN access credentials to user;

integration of billing between cellular and WLAN networks, one customer, one billing entity; and

standard protocol interface between WLAN and the cellular systems.

### SUMMARY OF THE INVENTION

The present invention makes it possible for a customer in a cellular network such as GSM, GPRS, CDMA, UMTS or other standards, to use his or her cellular network customer identity to get authenticated and open an access account in a data communication network, such as a WLAN public access network. The billing relation with the customers' cellular network operator will be used for billing of the WLAN services as well.

### ABBREVIATIONS AND EXPLANATIONS

Below, some of the abbreviations used in this description are explained.

APIS Application Interface Program Server

CDMA Code Division Multiple Access

CDR Call Detail Record

CORBA Common Object Request Broker Architecture. CORBA is an architecture and specification for creating, distributing, and managing distributed program objects in a network. It allows programs at different locations and developed by different vendors to communicate in a network through an “interface broker”.

GGSN Gateway GPRS Service Node

GPRS General Packet Radio Services

GSM Global System for Mobile Communications

HLR Home Location Register

IMSI International Mobile Subscriber Identity Number. The IMSI is a unique non-dialable number allocated to each mobile subscriber in the GSM system that identifies the subscriber and his or her subscription within the GSM network. The IMSI resides in the SIM, which is transportable across MSE. The IMSI is made up of three parts (1) the MCC, consisting of three digits, (2) the MNC, consisting of two digits, and (3) the MSIN with up to 10 digits.

LCP Local Connection Point. The term LCP is used to describe a group of access points having a common profile.

LDAP Lightweight Directory Access Protocol

MCC Mobile Country Code

MNC Mobile Network Code

MSE Mobile Station Equipment. GSM carriers typically order Mobile Station Equipment (MSE), such as GSM phones, from their suppliers, e.g. Ericsson®, Sony®, etc., in large quantities, e.g. 1000 Units. After receiving an order, the equipment supplier will program the ordered MSE SIMs with a range of IMSI numbers.

MSIN Mobile Subscriber Identity Number

MSISDN Mobile Subscriber ISDN Number. The MSISDN is the dialable number that callers use to reach a mobile subscriber. Some phones can support multiple MSISDNs—for example, a U.S. based MSISDN and a Canadian based MSISDN. Callers dialing either number will reach the subscriber.

RADIUS Remote Authentication Dial-In User Service. The RADIUS is a client/server protocol and software that enables remote access servers to communicate with a central server to authenticate dial-in users and authorize their access to the requested system or service.

RLAS Radio Login Access Server. The RLAS is the server to which the access points, e.g. radio antennas and TRX are connected.

SAS Statistics and Accounting Server

SCS System Control Server

SDL System Data Layer

SGSN Serving GPRS Support Node

SIM Subscriber Identity Module

SMS Short Message Service

SUP Sign-Up Server. The Sign-Up Server is sometimes also abbreviated as SUS.

UMTS Universal Mobile Telecommunications System

URL Uniform Resource Locator

VLAS Virtual LAN Access Server. The VLAS is a generalized access server and firewall which facilitate access, accounting and authorization functions as well as service control and security tasks. VLAS manages user interaction and monitors user communication according to user profile information.

WLAN Wireless Local Area Network

### BRIEF DESCRIPTION OF THE DRAWINGS

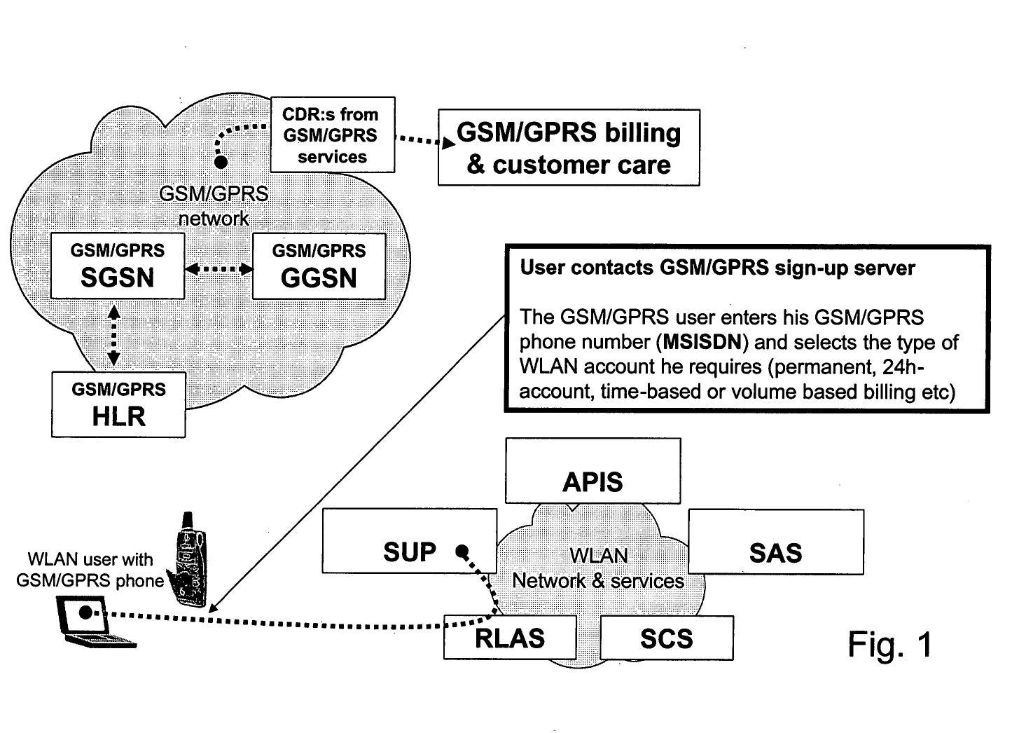

Further effects, details and advantages of the system and method according to the present invention are shown by way of example on the accompanying drawings, in which FIGS. 1-6 illustrate chronological steps according to an embodiment of the present invention, realized with a GSM/GPRS cellular network.

### DETAILED DESCRIPTION

The present invention refers to communication between a data communication network and a cellular network, enabling a cellular network customer to use his customer ID to access services in the data communication network. Especially, the present invention refers to communication between a wireless data communication network, such as a WLAN, and a cellular network. The connection between the networks also enables billing information, i.e. consumption of the data communication network service, to be communicated to the cellular network billing system.

An embodiment wherein the cellular system and network is GSM is shown by way of example in the drawings, to which this description refers. The person skilled in the art realizes, however, that the invention is applicable also to other types of cellular systems and networks. Further, the invention will be described below with reference to a wireless LAN, i.e. to a so-called WLAN, but it should be understood that the invention also is applicable to a LAN.

In the illustrated embodiment, separate terminals, e.g. a mobile phone and a portable computer, are used for communication with the cellular network and the WLAN, respectively. However, in alternative embodiments according to the present invention, these communication functions may be implemented in one and the same terminal device, such as in a Personal Digital Assistant, PDA, or other suitable equipment.

According to the illustrated embodiment, the authentication of a cellular network customer in a WLAN hot spot area, i.e. in an area where a WLAN operator provides a WLAN service, is made possible by a Sign-up server (SUP). The customer enters his cellular phone number (MSISDN) and selects the type of WLAN account he desires. The WLAN account can for example be a permanent account or a time-limited account, e.g. a 24 hours account, but it can also be an account comprising timed-based or volume-based billing etc, cf. FIG. 1.

Further, the WLAN operator has an agreement with one or several cellular operators, which agreement allows the WLAN operator to offer services to the cellular operator's customers. Information about allowable services are stored in the HLR of the cellular operator's customer. Thus, when the customer enters his cellular phone number and selects a desired account, the customer also enters the identity of his cellular operator.

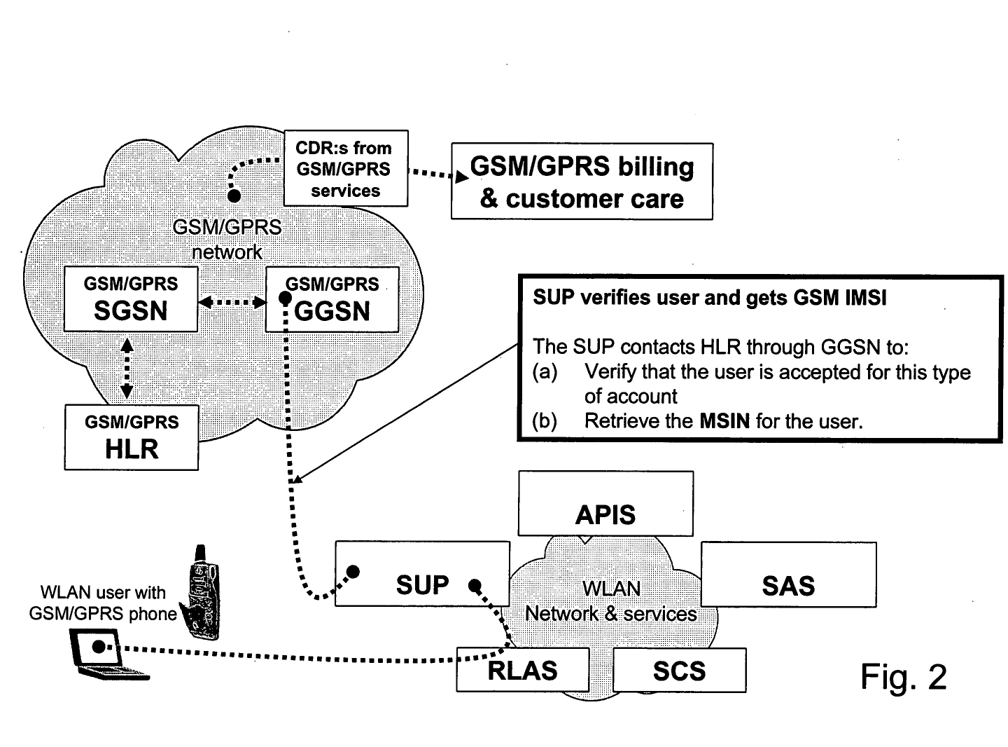

The SUP contacts the cellular network's Home Location Register (HLR) via a Gateway GPRS Service Node (GGSN) to verify that the customer is accepted for the selected type of account and to get customer identification information, such as the customer's Mobile Subscriber Identity Number (MSIN), cf. FIG. 2. If the customer have entered an incorrect cellular operator or if the WLAN operator is not allowed to provide services to customers, the SUP is prevented from retrieving the customer's MSIN.

The HLR comprises thus a storage structure, such as a database, comprising information about which service or services the user has access to, i.e. if the user has access to e.g. SMS, mobile answering etc.

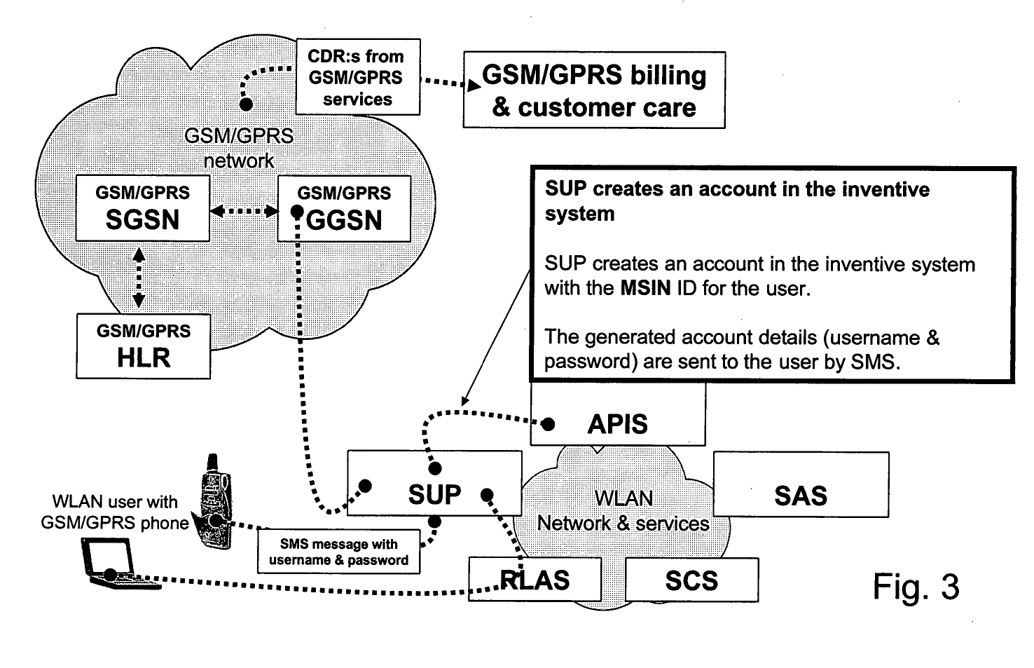

After the retrieval of the MSIN, the SUP creates an account in the system of the WLAN network, for example in a storage structure connected to an Account Program Interface Server (APIS). The created account comprises the customer identification information (MSIN) and the selected account type. Further, the SUP generates account details, such as username and password, which are stored together with the customer identification number and the selected account type in the APIS. The generated account details, e.g. username and password, are also sent to the users'cellular terminal by for example SMS or e-mail, cf. FIG. 3.

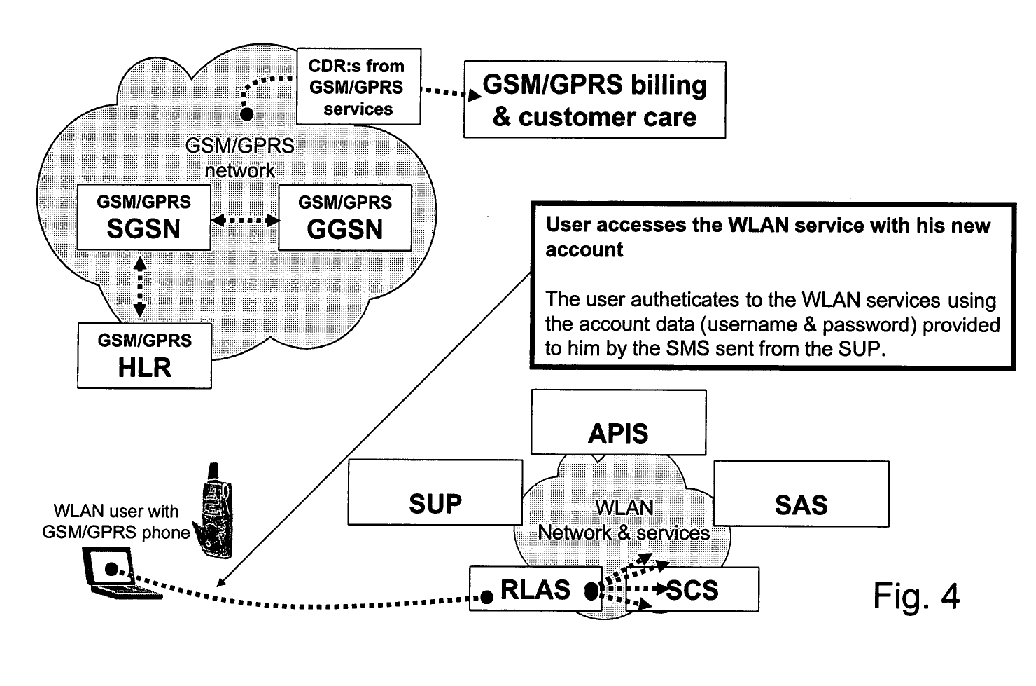

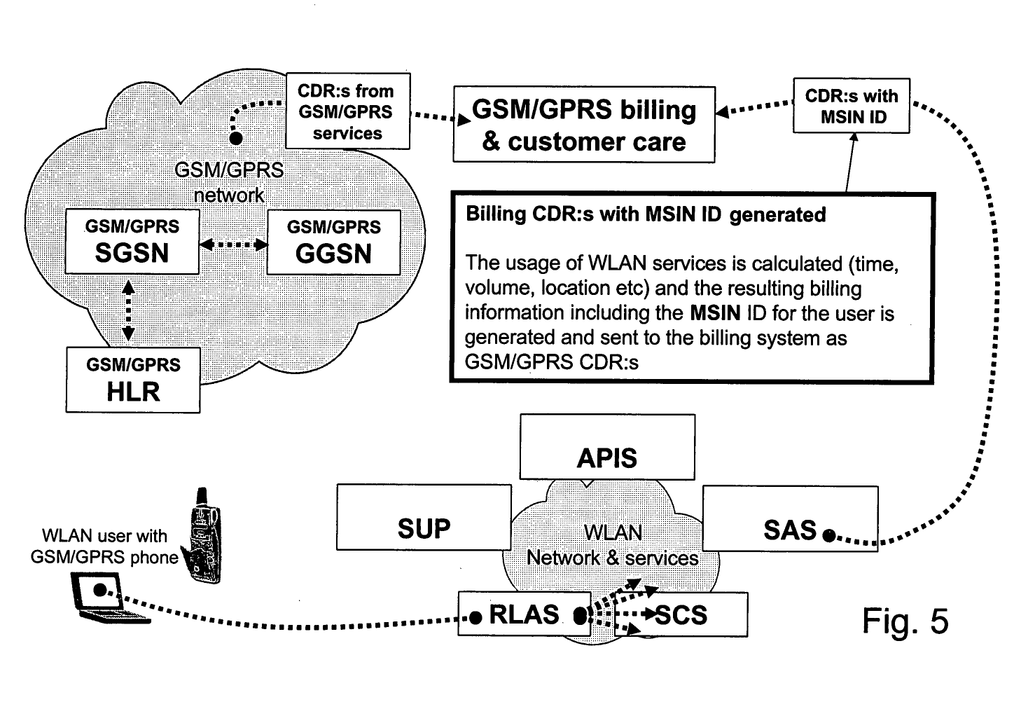

The user authenticates to a service or services provided by the WLAN by means of the generated account details, which were sent to him, cf. FIG. 4. The usage of WLAN services is calculated based on e.g. the consumed time, volume or location, and the resulting billing information including the MSIN ID is sent to the cellular network billing system as GSM/GPRS Call Detail Record (CDR:s), cf FIG. 5. The customer get billed by the cellular network operator.

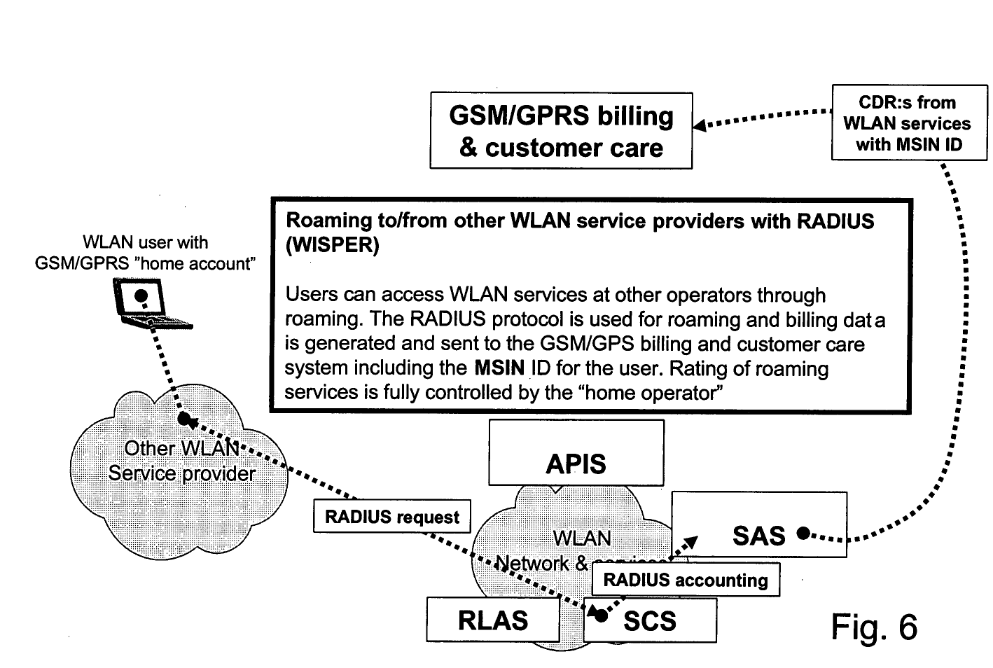

The present invention provides also functionality for roaming. In FIG. 6 is shown how a WLAN user having a GSM/GPRS home account can access WLAN services from other WLAN operators through roaming. The RADIUS protocol is used for roaming. The billing data is generated and sent together with the user's MSIN ID to the GSM/GPRS billing and customer care system in accordance with the procedure described herein. Further, the rating of the roaming services is controlled by the WLAN user's home operator in the same way as the home operator normally rates cellular calls or other data services.

The present invention hence provides a structured way to communicate between a data communication network, such as a WLAN, and a cellular-network, enabling a cellular network customer to use his customer ID to access the services in a WLAN. The connection between the networks also enables billing information, i.e. consumption of the WLAN service, to be communicated to the cellular network billing system.

As a result, the customer can in a much easier way than today get access to and use public WLAN networks. This is achieved by letting the customer use his existing relation with a cellular network operator. The billing are simplified—the customer gets one bill for all his wireless services, and access and authentication is also made easier since it is performed towards the cellular network.

An embodiment of the inventive system comprises a login access point, such as a Radio Login Access Server (RLAS) or a Virtual LAN Access Server (VLAS) to which an end user's computerized device is communicatively connectable or connected. Further, the inventive system comprises a Sign-Up Server (SUP), an Application Program Interface Server (APIS), a Statistics and Accounting Server (SAS) and a System Control Server (SCP). These components of the inventive system will now be more thoroughly described.

### Physical Components

The physical components are the units that comprise the physical elements of the inventive system. The units are preferably computerized devices that have been adapted to meet the needs of the system. Depending on the system configuration, certain parameters will vary, others are common to all units.

System software or computer code portions is/are preloaded and includes an operating system that is common to all units. System surveillance is managed by an information manager, e.g. an Information Management (IM) subsystem, which is arranged to transfer control and surveillance data using a network management protocol, such as a Simple Network Management Protocol (SNMP). The IM is implemented throughout the system. To ensure secure terminal access to the system a Secure Shell (SSH) software can be used and communication between nodes or components is protected with encryption software. Time keeping can be performed by means of a time protocol client, such as a Network Time Protocol (NTP) client, which can be implemented in one or several units.

Login Access Points RLAS/VLAS

The Radio Login Access Server (RLAS) and/or the Virtual LAN Access Server (VLAS) are the parts or nodes of the system that are closest to the end user. The login access points are arranged to function as gathering points for a group of access points in the system. The RLAS and/or VLAS are arranged to handle initial login processes and prevent access to the data communication network until authentication data has been verified by the system, i.e. until the SCS has authenticated the end user. The RLAS/VLAS is further capable to download Local Connection Point (LCP) parameters that further filter who may access the network from a certain access point.

Via a WLAN, a Digital Subscriber Line (DSL) or via some other means, an end user's computerized device is communicatively connectable to the RLAS and/or the VLAS. Independently of the configuration, all Internet traffic by an end user will pass through the RLAS or the VLAS.

An end user can communicate, by means of a laptop, workstation or another suitable computerized device, via a modem with a base station or another public network utility. The base station is in its turn connected to the RLAS/VLAS Ethernet. The initial authentication procedures are handled in the RLAS/VLAS and once the customer credentials have been processed by the system the customer will have access to the service he subscribes to.

The RLAS/VLAS has repeated contact with the SCS and every login attempt goes through the authentication procedure. This involves contacting the SCS comprising the user identification, e.g. usernames and passwords. The RADIUS is an authentication system that can be used to verify end users. The RADIUS client is located in the RLAS/VLAS and the RADIUS server in the SCS.

Accounting data is triggered by an authentication request and these request are recorded in the SCS database before being relayed to the SAS by means of an account manager, such as an Account Management (AM) subsystem. Once an end user has been authenticated, the RLAS and/or VLAS requests a copy of the product profile data associated with the user in order to build the applicable filter. Further, the SAS is configured to communicate with the RLAS/VLAS via a network manager, such as a SNMP, to retrieve statistical data for example the number of users in session.

The RLAS/VLAS can further be arranged to make a request to find out whether for example branding is indicated in the product profile or not, and if so the specific branding to be used. Branding information can in such cases be included in the LCP parameters. This branding information can be important from a billing point of view since billing information sent to the SAS includes LCP data that can be used to vary the billing models.

Further, a web server is arranged to present the login page to the end user and a mail server is arranged to send a message to a predetermined mail address if the integrity of files is breached.

Sign-Up Server SUP

SUP or SUS is the Sign-Up Server used for all on-line registration of customers, SUP also handles the registration and validation of credit card customers. The SUP is communicatively connected to the login access points, i.e. the RLAS and/or the VLAS, and to the APIS. Further, the SUP is arranged to communicate with a cellular network's Home Location Register (HLR) via a Gateway GPRS Service Node (GGSN) to verify that the customer is accepted for the selected type of account and to get customer identification information, such as the customer's Mobile Subscriber Identity Number (MSIN). The SUP can be configured to contact the HLR via for example the SS7 protocol or another protocol used in the public switched telephone system for setting up calls and providing services.

After retrieval of the MSIN, the SUP creates an account in the APIS and generates a customer specific username and password. The generated account details are stored in the APIS together with the MSIN ID for the customer and information about the type of the account. The SUP is further arranged to send the generated username and password to the customer. For example, the SUP can be arranged to send the generated account details by SMS or voice messaging using a voice mail system to the customer's cellular phone, or by an electronic mail to the customers computer. To provide a secure transfer of the generated account details, the SUP can be arranged to use the means for encryption provided for in GSM systems.

When the customer has received his account details, he can authenticate to the WLAN services using his username and password.

Thus, the SUP is configured to handle the initial registration dialogue with a customer, to create accounts and generating account details. However, the SUP can also be arranged to allow a customer to terminate an existing account. Thereby providing a dynamic handling of customers and the belonging accounts.

Further, the SUP can be configured to communicate with a commercial validation system for on-line charging, which validation system is comprised in for example a bank or a credit card institution. This can for example be desirable when the cost for the provided WLAN services are to be withdrawn from the customer's bank account or credit card. Thus, by means of the SUP it is possible for the end user to buy an account and pay for the services by means of the end user's credit card or the like.

Application Program Interface Server APIS

The Application Program Interface Server (APIS) comprises a storage structure, such as a database, for storing configuration data. User's configuration data are created by means of the SUP and stored in the APIS. New configuration data is sent to the APIS and information required by other storage structures in the system is distributed from the storage structure in APIS. In most situations, the configuration data is not static and thus needs to be changed from time to time. Updating of the configuration data can be done from a system console.

A Total Network Application Program Interface (TNAPI) can be comprised in the APIS. The TNAPI is a CORBA based interface, which is used for communication with CABS or an external customer system. Once a time-limited voucher has been activated the SAS acts as the timekeeper and once the time limit has expired a two-way communication is set up between the SAS and the APIS. The SAS initiates the communication by requesting data on the voucher concerned and once the information is received, the SAS will send an account revocation command to the APIS.

Once an administrative user has configured new products and added users, the new information has to be sent to the SCS:s. A configuration manager, such as a Configuration Management (CM) subsystem, is designed to handle the movement of configuration data over the Message Bus (MB). Thus the CM sends information from the APIS to the SCS:s. The CM monitors changes in the APIS database and is activated when they occur.

Communication with a customer administration system is preferably performed via a platform independent architecture, such as the CORBA interface. Such a customer administration system is then configured as a CORBA client, which can access the APIS storage structure.

System Control Server SCS

The System Control Server (SCS) is communicatively connected to the APIS, SAS and RLAS/VLAS servers comprised in the inventive system. The SCS is arranged as a central node for a number of RLAS/VLAS and it is arranged to store a copy of the configuration information that it receives from an APIS, i.e. the passwords and customer information necessary to authenticate end users. Each time an end user logs on to the system a start post is generated. Logging off from the system generates a stop post. These are important from an accounting point of view since these records form the basis of any billing system.

In the event of a positive response to an authentication request, information regarding the end user's unique product profile associated with the end user's account will be retrieved from the storage structure comprised in the SCS. Thus the SCS is arranged to determine what services the end user is entitled to use.

Further, the SCS is configured to send accounting information to the SAS and keeps track of active users. The accounting data is sent to the SAS by the Account Management (AM) subsystem over the message bus. A program in the SCS monitors the local database for changes and is activated when changes are detected. Among these changes are start and stop posts which are forwarded to the SAS.

Remote authentication is handled by RADIUS, which is implemented in the system. The SCS comprises a RADIUS server that handles radius requests originating from end users. Authentication requests identified as belonging to roaming end users are initially handled by leaf SCS:s that relay these to dedicated SCS:s in the system acting as external RADIUS gateways. This is done in order to compile all roaming information in one or two locations making it easier for the individual operator who is then only required to configure external servers on the so-called SCS gateways. It also simplifies matters for roaming partners who are only required to configure one, or at most a few clients and remote servers on their terminals.

Statistics and Accounting Server SAS

The Statistics and Accounting Server (SAS) is arranged to communicate with external billing systems, CABS, APIS, SCS:s and Access Servers Further, the SAS is arranged to collect billing data, usage data and to revoke time-limited accounts.

The SAS comprises a storage structure, e.g. a database, which comprise accounting data and usage data, programs for processing statistical data and modules for monitoring time-limited accounts. Information, such as start and stop data for each user session, is sent to the SAS from the SCS using the Account management (AM) subsystem. Together with other data, such as the number of bytes sent and/or received, the session duration data is stored in the storage structure of the SAS. The stored information is processed in the SAS before being sent on to an external management system, such as a Netware Management System (NMS), or requested by a Customer Administration and Billing Server (CABS).

The SAS is further arranged to communicate with the APIS to disable accounts that are no longer valid. The task of revoking time-limited accounts is a function handled by the SAS. Time-limited account data is stored in the APIS and the SAS receives start and stop data which it stores in its database. Start and stop data is always accompanied by user ID. The SAS contains a user data reference base. It uses the information stored here to cross check with the APIS as to whether a particular user account exists and what rights it has. If discrepancies are found, a revocation command is sent to the APIS that disables the account.

Usage statistics provided by the SAS, can give the operator valuable information about how the system is utilized. Dimensioning networks is a dynamic process where some areas may need reinforcement and some resources might be underutilized. Usage statistics are retrieved from the RLAS/VLAS by the SAS. The retrieved usage information can for example comprise the number of active sessions in an access point at any time, the number of leases considered active, the number of leases considered free, the total number of IP addresses that can be leased and the ratio in percent of the number active leases and the total number of available leases. This information kind of statistic information can be provided by the SAS and sent to a CABS.

Customer Administration and Billing Server CABS

A Customer Administration and Billing Server (CABS) is a server unit arranged to generate the user interface presented in a system console and arranged to administer all aspects of the system. The CABS specific software handles the input and output data to and from the system console.

The main functions of CABS are to store customer data, present information, such as billing and statistical data, in the system console and communicate with the system through the APIS and the SAS. Further, the CABS can be arranged to deactivate or delete a customer's account.

The CABS retrieves statistical data from the SAS and by means of the system console the administrator can retrieve accounting data and statistics. For example, the operator can search for system usage statistics by requesting a usage report which will include data regarding the total number of users, number of sessions, average session time, average incoming traffic per user and other statistical information.

SDL data can further be altered via the system console. Via for example a CORBA interface between the APIS and CABS, the APIS databases can be read and edited. In this way a system user with the applicable rights can exercise considerable control of the system.

When the system is configured, a super-administrator creates user product profiles, in the number and with the level of authorization required. An end user will thus be associated with a product profile that determines what rights the user is entitled to exercise. In this regard the system is extremely flexible, allowing many variations.

When the administrator add a new Virtual Internet Service Provider (VISP) or changes a user profile via the system console, the new data has to be stored in the APIS database. Thus, the content of the APIS database is changed.

The communication methods employed in CABS are based on the CORBA standard. This makes it possible for pieces of programs called objects to communicate with each other regardless of operating system or computer language. Remote communication and control are easier to implement. Built up with CORBA in mind the Total Network Application Program Interface (TNAPI) is designed to interface with internal and external systems. This means that almost any operator customer and billing system can be used together with the inventive system.

CABS is a complete and independent customer administration and billing system, however operators with existing legacy systems of their own may wish to use the systems they have instead of having dual systems. The TNAPI interface in the APIS is designed for this kind of flexibility. As long as the legacy system supports CORBA it is relatively easy to configure as a CORBA client and in this way exclude CABS from the system.

The graphical presentation of information in the system console is presented as an interactive web page. The web server's primary function is to fetch and display web pages such as the login page on the system console. When the system console is in use, the set of web pages that make up the graphic interface between the user and the system are delivered to the system console by the web server. Most system data is stored in APIS databases apart from some specific end customer data that is stored in the CABS database, such as information about the customer's home address or telephone number.

User Application Server UAS

Embodiments of the inventive system can also be arranged to comprise a User Application Server (UAS). The UAS is a server arranged to provide configuration and generation of user applications. This node is dedicated to end user services like e-mail and the possibility of publishing personal home pages. The mailboxes and home page repositories required are housed in the UAS. All data access, and the distribution of user accounts, is performed through the SCS.

The UAS is communicatively connected to the APIS for the creation of home directories, which are the repositories for end customer home pages. When new customers are registered and their product profile includes the right to a home page, the APIS will send this information to the database in the UAS.

Further, UAS is also arranged to start an authentication procedure of an end user, since each time an end user wishes read or send mail he/she has to log on to the mail server. This initiates the authentication process using the RADIUS system. The UAS makes contact with the SCS. The RADIUS client in the UAS sends a request to the RADIUS server in the SCS. The RADIUS server queries the LDAP directory in the SCS for authentication and additional data. Security is maintained by the use of symmetrical encryption keys.

Certain product profiles can include notification of new incoming email via SMS. Information about what kind of product profile that matches a certain account is stored on the SCS database The UAS can be arranged to retrieve this and other accounting data using LDAP.

The system for billing access or usage of a wireless data communication network by intercommunication with a cellular network according to the present invention, comprise means for performing the steps and the functions of the method. Many of the means can be realized as hardware units and most of them are advantageously implemented as computer programs, executing on hardware parts of the arrangement. In particular, a computer program product, for use with a system for billing access or usage of a wireless data communications network by intercommunication with a cellular network, for carrying out an embodiment of the present inventive method and realizing an embodiment of the inventive structure comprises a recording medium and means for performing said method and realizing said structure recorded on the storage medium.

1. A system for billing access or usage of a data communication network by intercommunication with a cellular network comprising a cellular network billing system, the system comprising:
a login access point (RLAS, VLAS) configured for communication with an end user's computerized device and for handling an end user's access to said data communication network;
a sign-up server (SUP) communicatively connected to said login access point (RLAS, VLAS), configured to verify if said end user is accepted for accessing said data communication network by communicating with said end user's cellular network, configured to create an end user account and to generate end user specific account details;
an application program interface server (APIS) communicatively connected to the sign-up server (SUP);
a system control server (SCS) communicatively connected to said login access point (RLAS, VLAS), said sign-up server (SUP), and to said application program interface server (APIS), and configured to control the access to said data communication network; and
a statistics and accounting server (SAS) communicatively connected to said application program interface server (APIS) and to said system control server (SCS), and configured to generate billing information and to send said billing information to said cellular network billing system;

2. The system according to claim 1, wherein said sign-up server (SUP) further is configured to communicate with a Home Location Register (HLR) of said cellular network via a Gateway GPRS Service Node (GGSN).

3. The system according to claim 2, wherein said sign-up server (SUP) further is configured to retrieve an end user identification number from said home location register (HLR) and to authenticate said end user.

4. The system according to claim 3, wherein said end user identification number is said end user's mobile subscriber identity number (MSIN).

5. The system according to claim 1, wherein said sign-up server (SUP) further is configured to create said end user account in said application program interface server (APIS).

6. The system according to claim 1, wherein said sign-up server (SUP) further is configured to send said end user specific account details to said end user by means of said cellular network.

7. The system according to claim 1, wherein said login access point (RLAS, VLAS) is arranged to receive end user specific account details to verify said end user and to provide access to said data communication network.

8. The system according to claim 1, wherein said end user specific account details comprises username and password.

9. The system according to claim 1, wherein said sign-up server (SUP) further is configured to communicate with a commercial validation system for on-line charging of said access.

10. The system according to claim 1, wherein the data communication network is a wireless data communication network.

11. A method for billing access or usage of a data communication network by intercommunication with a cellular network comprising a cellular network billing system, the method comprising the steps of:
by means of a computerized device communicating with a login access point (RLAS, VLAS);
entering an end user's cellular phone number;
selecting a desired account type;
communicating with an end user's cellular network to verify if said end user is accepted for accessing said data communication network;
creating an end user account;
generating end user specific account details;
controlling said access to said data communication network;
generating billing information related to said end user's access to said data communication network; and
sending said billing information to said cellular network billing system;

12. The method according to claim 11, further comprising the step of communicating with a Home Location Register (HLR) of said cellular network via a Gateway GPRS Service Node (GGSN).

13. The method according to claim 12, further comprising the steps of retrieving an end user identification number from said home location register (HLR) and authenticating said end user.

14. The method according to claim 11, further comprising the step of sending said end user specific account details to said end user by means of said cellular network.

15. The method according to claim 11, wherein said end user specific account details comprises username and password.

16. The method according to claim 11, further comprising the step of accessing said data communication network by means of said end user specific account details.

17. The method according to claim 11, further comprising the step of communicating with a commercial validation system for on-line charging of said access.

18. A computer program product for billing access or usage of a data communication network by intercommunication with a cellular network comprising a cellular network billing system, the computer program product comprising means for carrying out the steps of claim 11.
